(19) United States
(12) Patent Application Publication
(10) Pub. No.: US 2011/0285549 A1
(43) Pub. Date: Nov. 24, 2011

(54) SERVICE VEHICLE SAFETY BAR

(76) Inventor: Joseph John DESTRO, Brunswick, OH (US)

(21) Appl. No.: 13/103,464

(22) Filed: May 9, 2011

Related U.S. Application Data
(60) Provisional application No. 61/347,108, filed on May 21, 2010.

(51) Int. Cl. G08G 1/0955

(52) U.S. Cl. 340/908

(57) ABSTRACT

The present invention relates to a full functioning service vehicle safety bar and sign assembly. A light system that utilizes a wiring harness assembly equipped with flashing directional arrows (<<<), the word SLOW or a combination of both. This light bar is mounted to a traveling device that allows the light bar to be extended beyond the parameters of its own frame to either the drivers side or the passengers side of the vehicle to which it is mounted. The unit can be mounted to the vehicle permanently or via a dual mount hitch and receiver system (i.e. the hitch can be mounted just inside the rear wheel wells where the under frame allows). The hitch and receiver system is comprised of dual female receptacles mounted to the vehicles frame inside the wheel wells where body type allows with male tongs fitting snugly into the receptacles secured with a locking device.

### CROSS-REFERENCE TO RELATED APPLICATIONS

This application claims the benefit of provisional application No. 61/347,108 filed on May 21, 2010.

### BACKGROUND OF THE INVENTION

Where as it is well documented that the most dangerous situations faced by Police Force and Safety Service personnel is when they are assisting citizens on the highways.

It is also well documented that the flashing red and blue lights of a police vehicle mesmerizes drivers, which causes them to veer towards the lights instead of away from them. This phenomenon makes for a potentially very dangerous situation.

### BRIEF SUMMARY OF THE INVENTION

A service vehicle safety bar signal assembly and method.

It is also well documented that the flashing yellow lights calm a driver by warning them of a potential danger, which causes then to anticipate receiving further instructions.

The Service Vehicle Safety Bar is designed to reduce the mesmerizing effect of flashing red and blue lights by incorporating flashing yellow arrows and to give instruction and direction to oncoming drivers to slow down and move over.

As a vehicle approaches a safety vehicle using the Service Vehicle Safety Bar The device gives them visual direction and instruction to slow down and move to another lane.

Advantageously, the Service Vehicle Safety Bar adds a layer of protection for the Police Force and the Safety Service personnel when they are assisting citizens on the highways.

### BRIEF DESCRIPTION OF THE DRAWINGS

FIG. 1 shows a Prior Art highway situation with a Police vehicle assisting a motorist; and note when space allows Police men occasionally park their vehicles at a slight angle to add additional protection.

FIG. 2 shows a highway situation with a Police vehicle assisting a motorist with the Service Vehicle Safety Bar deployed.

FIGS. 3A and 3B show the Service Vehicle Safety Bar attached to a police vehicle in a stowed position and a deployed position, respectively.

FIGS. 4A, 4B, and 4C show the graphics of the Service Vehicle Safety Bar.

FIGS. 5A, 5B, and 5C show the top view, front elevation and side view, respectively, of the Service Vehicle Safety Bar and its internal components in the stowed position.

FIGS. 6A and 6B show the top view and front elevation, respectively, of the Service Vehicle Safety Bar in the deployed position.

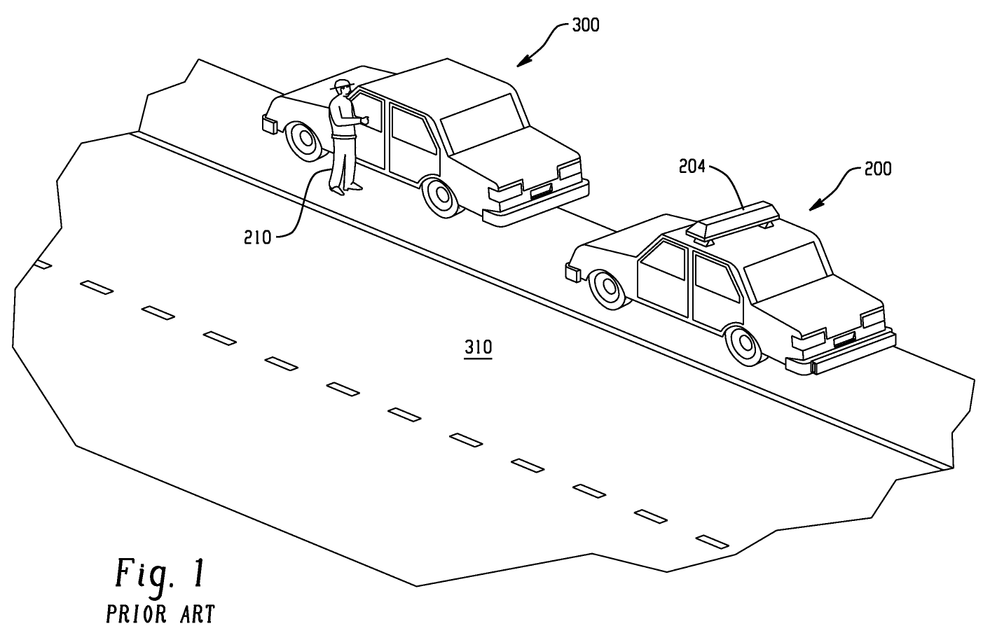

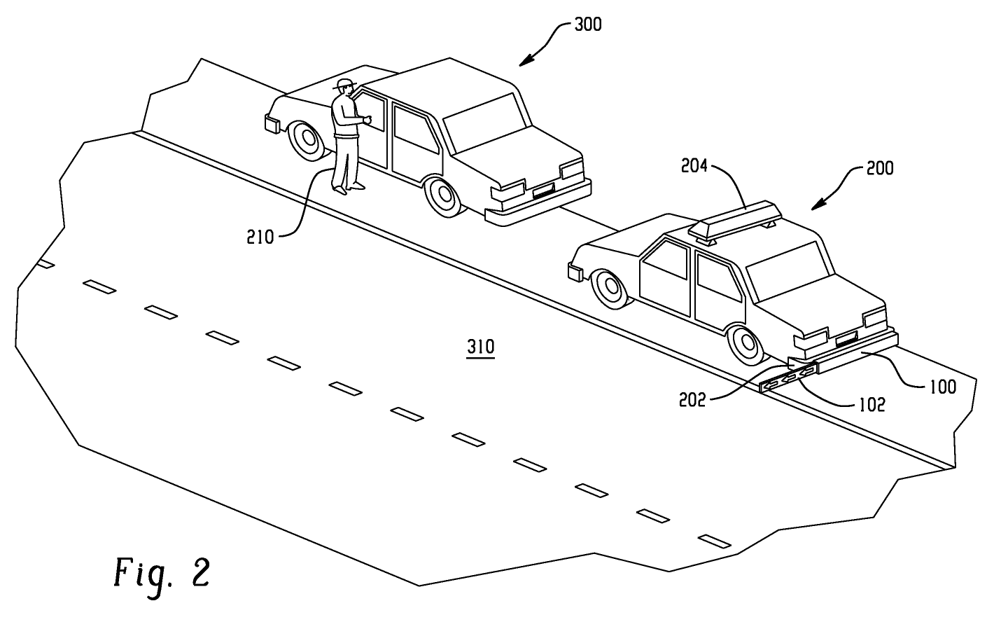

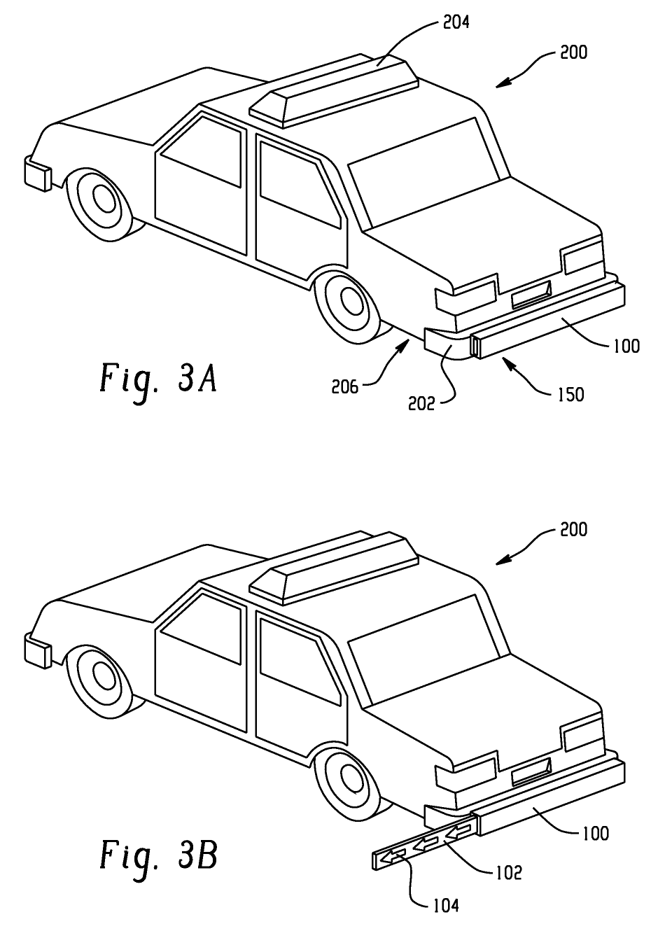

### DETAILED DESCRIPTION OF THE INVENTION

It is well documented that the flashing yellow lights calm a driver by warning them of a potential danger, which causes then to anticipate receiving further instructions.

The Service Vehicle Safety Bar 100 is designed to reduce the mesmerizing effect of flashing red and blue lights 204 by incorporating flashing yellow arrows 130a and to give instruction 130b and direction 130 to oncoming drivers to slow down and move over.

As a vehicle 300 approaches a safety vehicle 200 using the Service Vehicle Safety Bar 100 The device gives them visual direction and instruction 130 to slow down and move to another lane 310.

The Service Vehicle Safety Bar 100, is a retractable vehicle mounted 202 sign 102 using directional arrows 130a and/or programmable 122 light panels 104 or warn oncoming traffic and give visual 130 instruction 130b and direction 130a to provide increased security and safety to police and safety service employees 210 working and/or stopped on or near roadways 310.

The Service Vehicle Safe Bar 100 can be produced in various styles. For example, the dimensions of the exterior casing 110 can be 10″ to 12″ inches in height H, 62″ to 70″ inches in length L and 6″ to 10″ inches in depth D, though other dimensions could be used. The exact dimensions are determined by the particular type of unit 100 ordered based on the type of vehicle 200 it is to be mounted to. The exterior casing 110 may consist of two U shapes designed to interlock with each other.

The base plate and cover 140 can be constructed of U shaped steel or aluminum, though other materials could be used. The outer flanges of the base U shaped plate can have slots defined herein (e.g. 2¼″ wide by 8″ to 10″ high). These slots can be covered by a door with rubber grommets to protect the interior of the unit from moisture. The slot door can open and close as the unit is deployed. The base plate will have a series of drain holes to help alleviate moisture.

The U shaped top cover will inter lock with the base plate with a series of screws for easy access to the interior workings of the unit 100.

The interior of the unit 100 can include a LED light bar 102 (i.e. 2″ wide by 8″ to 10″ high) in one embodiment, the light bar 102 has 4 stabilizing rollers 106 (i.e. two on top and two at the bottom 12″ apart at one end of the unit). These rollers 106 can sit in a guide track 108. The light bar 102 can be attached to a threaded rod 112 which is then attached to a small 12 volt reversible drive motor 114. Power to the light bar 102 can be supplied via a cord 116 reel 117 mounted above or below the drive motor 114. The threaded rod 112 can be attached at one end the light bar 102, such as by a traveling clevis mount 118. At the other end of the unit 100, the rod 112 can be mounted to a fixed clevis mount 120. The threaded drive rod 112 can be ¼″ to ¾″ in diameter depending on the material used.

When deployed, the light bar 102 can extend E beyond its case 110 (i.e. approximately 42″) and display 130 either flashing yellow arrows 130a (<<<), the word 130b SLOW or a combination of both in one embodiment. The light bar 102 is deployed and retracted by a standard toggle switch located in the vehicle 200. The light bar 102 can also be wired 122 so that it will automatically retract when the vehicle 200 is shifted into drive.

The unit can be mounted to the vehicle permanently 202 or via a dual mount hitch and receiver system 150 (i.e. the hitch can be mounted just inside the rear wheel wells where the under frame allows). The hitch and receiver system can be constructed of Aluminum Steel and or any appropriate material. Power can be supplied to the unit via a 12 volt wiring harness.

Referring to the drawings, some elements were named or described by annotations in the original application drawings, however to correct informalities the annotations are moved to be incorporated in the present description, as follows:

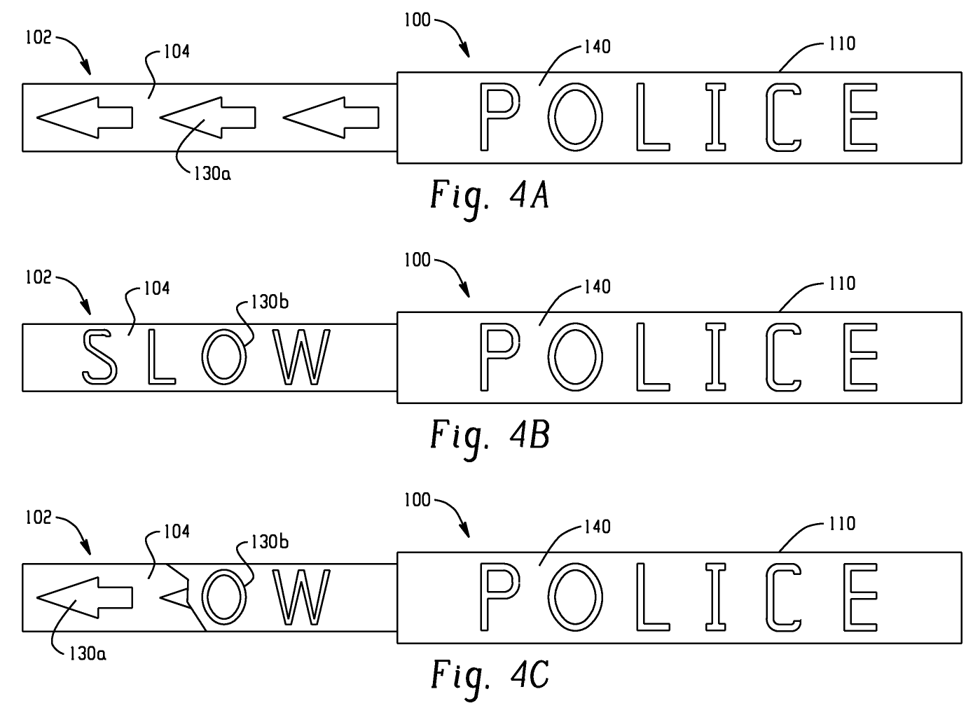

FIGS. 4A-4C illustrate display options, wherein:
FIG. 4A shows the sign 102 with a reflective Lexane panel 104 with either flashing or stationary light display 130a, and also shows a heavy-duty Lexane cladding 140 with high-visibility reflective coating and optional reflective message on the exterior casing 110.
FIG. 4B shows the sign 102 with optional flashing or stationary light display 130b.
FIG. 4C shows the sign 102 with optional flashing or stationary light display with two alternating messages 130a, 130b.

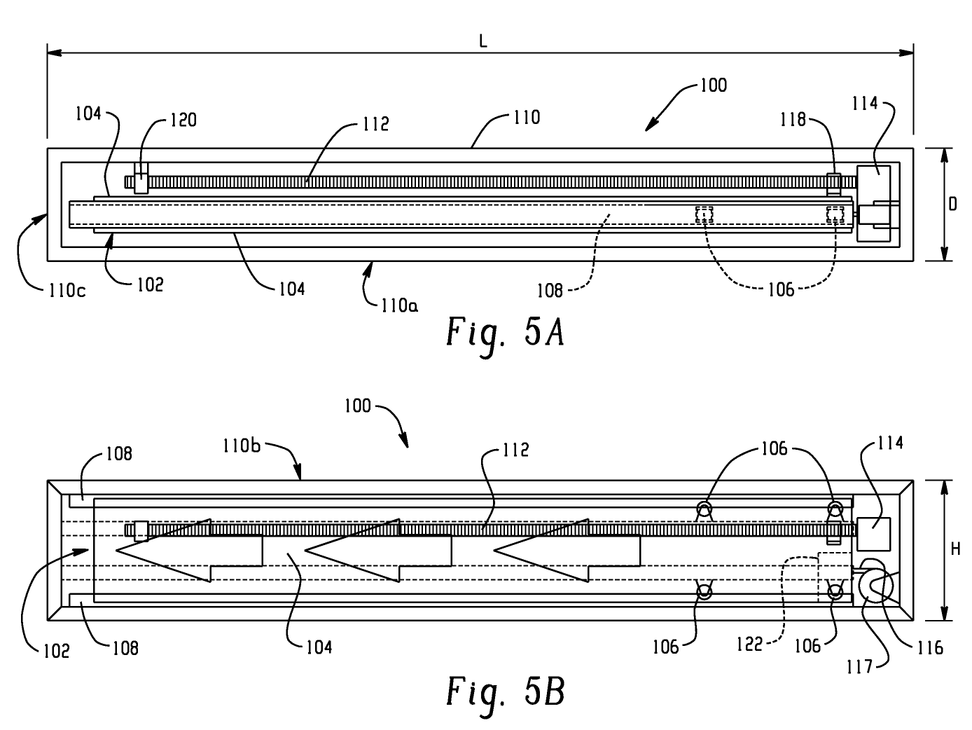

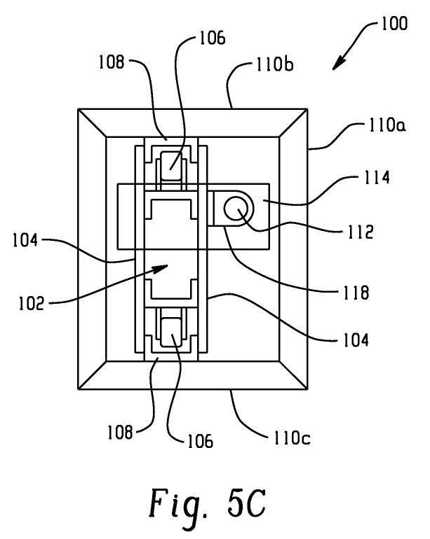

FIGS. 5A-5C illustrate the unit 100 in a stowed position, wherein:
FIG. 5A is a top view that shows the exterior casing 110 with a length L of 5′ 2″ and depth D of 8″; two plexiglass display panels 104 that measure 7¼″×4′ 6″; the fixed clevis 120 (frame mount); the ¾″ drive rod 112; the traveling clevis 118 (display mount); the drive motor 114; and two of the rollers 106.
FIG. 5B is a front elevation view which shows that the exterior casing 110 has a 1″ aluminum frame all around, and a height H of 10″; the upper channel rail 108 and the lower channel rail 108; the ¾″ drive rod 112; two rollers 106 in the upper channel rail 108 and two rollers 106 in the lower channel rail 108; and an electronics module 122.

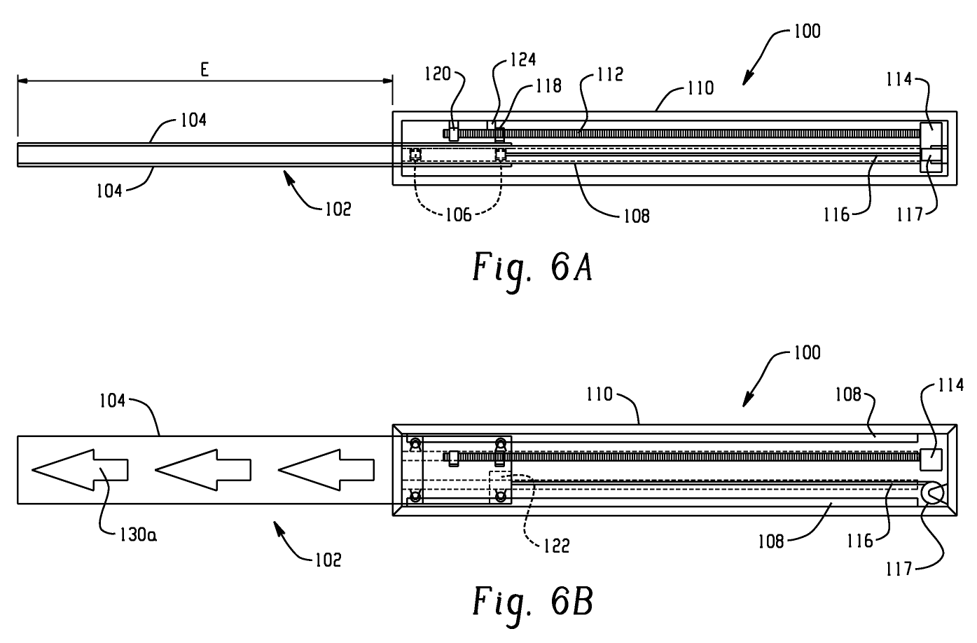

FIGS. 6A-6B illustrate the unit 100 in a deployed position, wherein:
FIG. 6A is a top view which shows that the deployed sign 102 has an extended length E of 3′ 5″; and also illustrates a part named as the limit switch 124.

What is claimed is:

1. Where as it is well documented that the most dangerous situations faced by Police Force and Safety Service personnel is when they are assisting citizens on the highways; that the flashing red and blue lights of a police vehicle mesmerizes drivers, which causes them to veer towards the lights instead of away from them, so this phenomenon makes for a potentially very dangerous situation; and that the flashing yellow lights calm a driver by warning them of a potential danger, which causes then to anticipate receiving further instructions; therefor a Service Vehicle Safety Bar is designed to reduce the mesmerizing effect of flashing red and blue lights by:
incorporating flashing yellow arrows and to give instruction and direction to oncoming drivers to slow down and move over; such that as a vehicle approaches a safety vehicle using the Service Vehicle Safety Bar the device gives them visual direction and instruction to slow down and move to another lane;
thereby the Service Vehicle Safety Bar adds a layer of protection for the Police Force and the Safety Service personnel when they are assisting citizens on the highways.
